(19) United States
(12) Patent Application Publication
(10) Pub. No.: US 2005/0228156 A1
(43) Pub. Date: Oct. 13, 2005

(54) Preparation of polyethylene films

(76) Inventors: Charles S. Holland, Coal City, IL (US); Harilaos Mavridis, Cincinnati, OH (US); Joel A. Mutchler, Morris, IL (US); Sandor Nagy, Naperville, IL (US)

Correspondence Address: LYONDELL CHEMICAL COMPANY, 3801 WEST CHESTER PIKE, NEWTOWN SQUARE, PA, 19073, US

(21) Appl. No.: 10/819,605

(22) Filed: Apr. 7, 2004

(51) Int. Cl. B32B 27/32; F16B 4/00

(52) U.S. Cl. 526/348.1; 428/523; 526/348.5; 526/348.6; 526/170; 526/943

(57) ABSTRACT

A very low density polyethylene (VLDPE) film is disclosed. The film has a high average heat seal strength and physical strength. The VLDPE has a density within the range of about 0.880 to 0.914 g/cm³. The film has a seal initiation temperature lower than or equal to 95° C. and an average heat seal strength greater than or equal to 1.75 lb/in. The film has a machine-direction (MD) modulus greater than or equal to 12,000 psi. The film can be used as a monolayer film or as a layer of a multilayer film. It is suitable for heat sealable bags and many other applications.

### FIELD OF THE INVENTION

The invention relates to polyethylene films. More particularly, the invention relates to very low density polyethylene (VLDPE) films.

### BACKGROUND OF THE INVENTION

Very low density polyethylene (VLDPE) films are increasingly used in heat sealable bags for packaging articles of food such as meats. It is important that once the food article is placed in the bag, the bag can be sealed easily to form an air-tight bond. Generally, the heat seal is formed by applying heat and pressure to the bag mouth to fuse the film together. It is also important that the bags can be sealed at a relatively low temperature. Heat sealing at high temperatures not only costs more energy but also causes uneven shrinkage along the sealing line of the bag.

Heat sealable bags must also be strong enough to survive the material handling, which may weigh over 100 pounds. Although it is highly desirable to make heat sealable bags having both high seal strength and high modulus, these two properties often go in the opposite directions. Thus, heat sealable bags are often made from a multiple layer film in which a VLDPE film is used as an inner layer to provide the bag with good sealing properties, while the outer layer is made from a higher density polyethylene which provides required physical strength.

Heat sealing bags made from multiple layer films often become deformed in the area where the heat is applied. A known solution to this problem is to crosslink the film layers by irradiation prior to heat sealing. Crosslinking the film provides improved physical properties and lowered heat deformation. However, crosslinked films often have higher seal initiation temperature and lower seal strength.

It is important to develop VLDPE films which can be sealed easily, have high seal strength, and have high modulus and other physical properties.

### SUMMARY OF THE INVENTION

The invention is a very low density polyethylene (VLDPE) film. The film has a low seal initiation temperature, high seal strength, and high modulus. The VLDPE has a density within the range of about 0.880 g/cm³ to 0.914 g/cm³. The film has a seal initiation temperature less than or equal to 95° C. It has an average heat seal strength greater than or equal to 1.75 lb/in. It has a machine-direction (MD) modulus greater than or equal to 12,000 psi. The film can be used as a monolayer film or as a layer of a multilayer film. It is suitable for heat sealable bags and many other applications.

### DETAILED DESCRIPTION OF THE INVENTION

The invention is a very low density polyethylene (VLDPE) film. The polyethylene has a density within the range of about 0.880 g/cm³ to 0.914 g/cm³. Preferably, the density is within the range of about 0.880 g/cm³ to about 0.912 g/cm³. More preferably, the density is within the range of about 0.900 g/cm³ to about 0.912 g/cm³. Density is measured according to ASTM D1505.

The film has good sealing properties. Its seal initiation temperature is 95° C. or lower. It has an average heat seal strength greater than or equal to 1.75 lb/in. Preferably, the average heat seal strength is greater than or equal to 2.0 lb/in. More preferably, the average heat seal strength is greater than or equal to 2.5 lb/in. Average heat seal strength is defined and measured according to ASTM F88-00. The film for the testing is prepared according to ASTM F2029-00.

The film also has high physical strength compared to known VLDPE films. It has a machine-direction (MD) modulus greater than or equal to 12,000 psi. Preferably, the MD modulus is greater than or equal to 14,000 psi. More preferably, the MD modulus is greater than or equal to 16,000 psi. MD modulus is measured according to ASTM D882 at 1 mil film thickness.

Preferably, the film has an MD tear strength greater than or equal to 50 grams. More preferably, the film has an MD tear strength greater than or equal to 60 grams. Tear strength is tested according to ASTM D1922 at 1 mil film thickness.

Preferably, the film has a dart-drop impact strength greater than or equal to 1,000 grams. More preferably, the dart-drop strength is greater than or equal to 1,200 grams. The dart-drop strength is tested according to ASTM 1709 at 1.0 mil film thickness.

The film also has good optical properties. Preferably, the film has a haze less than about 30%. More preferably, the haze is less than about 20%. The haze is tested according to ASTM D1003 at 1 mil film thickness.

The film of the invention has a low content of hexane extractables, measured according to FDA 21 CFR §177.1520. Preferably, the film has less than 0.8% of hexane extractables. More preferably, the film has less than 0.5% of extractables. Amount of extractables is measured using hexane as solvent.

Preferably, the VLDPE is made by an indenoindolyl-based single-site catalyst. By “indenoindolyl-based single-site catalyst,” we mean any single-site catalyst which comprises a transition metal complex having at least one indenoindolyl ligand. Indenoindolyl-based single-site catalysts are known, see e.g., U.S. Pat. Nos. 6,232,260, 6,376,629, and 6,414,162. The teachings of these patents are herein incorporated by reference. Examples of preferred indenoindolyl transition metal complexes include structure (I) and (II).

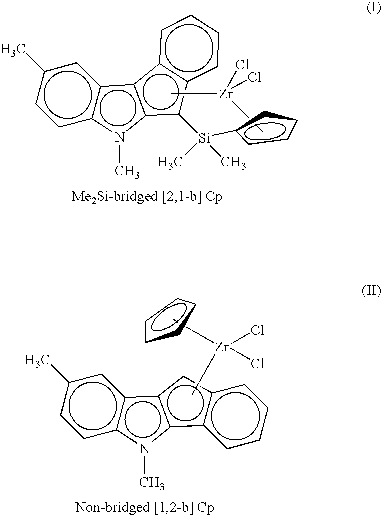

Preferred indenoindolyl transition metal complexes also include those which have so called “open architecture.” Open architecture indenoindolyl-based single-site catalysts are taught, e.g., by U.S. Pat. No. 6,559,251, the teachings of which are incorporated herein by reference. An example of an open architecture complex is shown in (III).

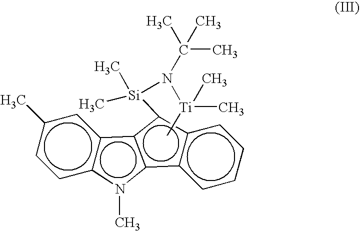

Preferred catalysts are supported on silica. Method for supporting indenoindolyl-based single-site catalysts onto silica are taught, e.g., by U.S. Pat. No. 6,583,242, the teachings of which are incorporated herein by reference.

Preferred VLDPE are ethylene/1-butene copolymers or ethylene/1-hexane copolymers. Preferably, the VLDPE has a weight average molecular weight (Mw) within the range of 50,000 to 150,000. More preferably, the Mw is within the range of 80,000 to 120,000. Most preferably, the Mw is within the range of 100,000 to 120,000. Preferably, the VLDPE has a molecular weight distribution (Mw/Mn) within the range of 2.0 to 3.0. Mn is a number average molecular weight.

The Mw, Mn and Mw/Mn are obtained by gel permeation chromatography (GPC) on a Waters GPC2000CV high temperature instrument equipped with a mixed bed GPC column (Polymer Labs mixed B-LS) and 1,2,4-trichlorobenzene (TCB) as the mobile phase. The mobile phase is used at a nominal flow rate of 1.0 mL/min and a temperature of 145° C. No antioxidant is added to the mobile phase, but 800 ppm BHT is added to the solvent used for sample dissolution. Polymer samples are heated at 175° C. for two hours with gentle agitation every 30 minutes. Injection volume is 100 microliters.

The Mw and Mn are calculated using the cumulative matching % calibration procedure employed by the Waters Millennium 4.0 software. This involves first generating a calibration curve using narrow polystyrene standards (PSS, products of Waters Corporation), then developing a polyethylene calibration by the Universal Calibration procedure.

Preferably, the VLDPE has a melt index MI₂ within the range of about 0.5 to about 30 dg/min, more preferably from 0.5 to 5.0 dg/min, and most preferably from 0.8 to 1.2 dg/min. The MI₂ is measured at 190° C. under 2.16 kg of pressure according to ASTM D-1238. In general, the higher the molecular weights, the lower the MI₂ values.

The polyethylene is converted into a film. Many film processes are known and can be used for making the film of the invention. Suitable film processes include cast film, high-stalk blown extrusion, and in-pocket blown extrusion processes. For instance, U.S. Pat. No. 4,606,879, the teachings of which are herein incorporated by reference, teaches the high-stalk blown film extrusion apparatus and method. The process temperature is preferably within the range of about 150° C. to about 210° C.

The film of the invention can be used as a mono-layer film or used as a layer of a multilayer film. Methods for making multilayer film are known. For instance, multilayer films can be made by co-extrusion process. In addition to the VLDPE, the multilayer film may comprise other layers such as gas-barrier, adhesive, medical, flame retardant layers, and the like. Suitable materials for the other layers include HDPE, LLDPE, LDPE, poly(vinylidene chloride), poly(vinyl alcohol), polyamide (Nylon), polyacrylonitrile, ethylene-vinyl acetate copolymers (EVA), ethylene-methyl acrylate copolymers (EMA), ethylene-acrylic acid copolymers (EAA), ionomers, maleic anhydride grafted polyolefins, K-resins (styrene/butadiene block copolymers), and poly(ethylene terephthalate) (PET), the like, and mixtures thereof.

The following examples merely illustrate the invention. Those skilled in the art will recognize many variations that are within the spirit of the invention and scope of the claims.

### EXAMPLE 1

A VLDPE (ethylene/1-hexene copolymer) is prepared with catalyst (I). The VLDPE has a density 0.911 g/cm³, Mw 114,350, Mw/Mn 2.88, and MI₂ 1.1 dg/min. The VLDPE is converted into film with 1 mil film thickness by a blown film process on a 4″ die, 100 mil die gap, and 2.5:1 blown-up ratio (BUR). The film exhibits an excellent combination of sealing properties and physical properties. The film has an MD modulus 16,600 psi, MD tear 91 g, dart-drop strength 1,715 g, haze 6.1%, and extractables 0.77%. It is sealed at 95° C. and gives an average heat seal strength of 1.75 lb/in.

### EXAMPLE 2

The general procedure of Example 1 is repeated, but the VLDPE has a density of 0.908 g/cm³, Mw 114,400, Mw/Mn 2.95, and MI₂ 1.1 dg/min. The film has an MD modulus 14300 psi, MD tear 91 g, dart-drop strength 1,690 g, haze 6.1%, and extractables 0.99%. It is sealed at 95° C. and gives an average heat seal strength of 1.9 lb/in.

### EXAMPLE 3

A VLDPE (ethylene/1-butene copolymer) is prepared with catalyst (II). The VLDPE has a density 0.907 g/cm³, Mw 116,000, Mw/Mn 2.36, and MI₂ 1.0 dg/min. The VLDPE is converted into film with 1 mil film thickness by a blown film process on a 4″ die, 100 mil die gap and 2.5:1 blown-up ratio (BUR). The film exhibits an excellent combination of sealing properties and physical properties. The film has an MD modulus 15,000 psi, MD tear 100 g, dart-drop strength 840 g, haze 18%, and extractables 0.80%. It is sealed at 95° C. and gives an average heat seal strength of 1.8 lb/in.

### EXAMPLE 4

The general procedure of Example 3 is repeated, but the VLDPE has a density of 0.904 g/cm³, Mw 113,000, Mw/Mn 2.45, and MI₂ 1.0 dg/min. The film has an MD modulus 11,700 psi, MD tear 67 g, dart-drop strength 1,060 g, haze 16%, and extractables 1.2%. It is sealed at 95° C. and gives an average heat seal strength of 2.5 lb/in.

### COMPARATIVE EXAMPLE 5

The general procedure of Example 3 is repeated, but the VLDPE is a terpolymer of ethylene/1-butene/1-hexene. It has a density of 0.911 g/cm³, Mw 114,000, Mw/Mn 2.34, and MI₂ 1.0 dg/min. The film has an MD modulus 166,000 psi, MD tear 175 g, dart-drop strength 1,200 g, and haze 9.2%. The film has much lower average heat seal strength than those in Examples 1-4. It is sealed at 95° C. and gives an average heat seal strength of only 1.4 lb/in.

### COMPARATIVE EXAMPLE 6

The general procedure of Example 3 is repeated, but the VLDPE has a higher density than those in Examples 1-4. It has a density of 0.915 g/cm³, Mw 108,000, Mw/Mn 2.43, and MI₂ 1.1 dg/min. The film has an MD modulus 190,000 psi, MD tear 210 g, dart-drop strength 1,690 g, and haze 9.4%. The film has much lower average heat seal strength than those in Examples 1-4. It is sealed at 95° C. and gives an average heat seal strength of only 0.8 lb/in.

### COMPARATIVE EXAMPLE 7

A commercial VLDPE, DOW PL-1840A (product of Dow Chemical Company) is converted into a film by the same process as described in Example 1. The VLDPE is an ethylene/1-octene copolymer which has a density 0.910 g/cm³, Mw 87,400, Mw/Mn 2.68, and MI₂ 1.0 dg/min. The film exhibits much lower average heat seal strength than those in Examples 1-4. The film has an MD modulus 14,500 psi, MD tear 140 g, dart-drop strength>1,950 g, haze 9.2%, and extractables 0.5%. It is sealed at 95° C. and gives an average heat seal strength of only 1.25 lb/in.

### COMPARATIVE EXAMPLE 8

A commercial VLDPE, DOW PL-1880 (product of Dow Chemical Company) is converted into a film by the same process as described in Example 1. The VLDPE is an ethylene/1-octene copolymer which has a density 0.905 g/cm³, Mw 92,600, Mw/Mn 2.63, and MI₂ 1.0 dg/min. The film exhibits much lower average heat seal strength and lower MD modulus than those in Examples 1-4. The film has an MD modulus only 10,000 psi, MD tear 155 g, dart-drop strength>1,950 g, haze 3.0%, and extractables 1.0%. It is sealed at 95° C. and gives an average heat seal strength of only 1.25 lb/in.

### COMPARATIVE EXAMPLE 9

A commercial VLDPE, DOW 4201 (product of Dow Chemical Company) is converted into a film by the same process as described in Example 1. The VLDPE is an ethylene/1-octene copolymer which has a density 0.912 g/cm³, Mw 128,000, Mw/Mn 4.23, and MI₂ 1.0 dg/min. The film exhibits lower average heat seal strength than those in Examples 1-4. The film has an MD modulus 18,000 psi, MD tear 285 g, dart-drop strength>1,950 g, haze 4.9%, and extractables 1.97%. It is sealed at 95° C. and gives an average heat seal strength of only 1.5 lb/in.

### COMPARATIVE EXAMPLE 10

A commercial VLDPE, Exact 3132 (product of ExxonMobil Chemical Company) is converted into a film by the same process as described in Example 1. The VLDPE is an ethylene/1-hexene copolymer which has a density 0.902 g/cm³, Mw 111,000, Mw/Mn 2.49, and MI₂ 1.1 dg/min. The film exhibits lower average heat seal strength and lower MD modulus than those in Examples 1-4. The film has an MD modulus only 9,770 psi, MD tear 100 g, dart-drop strength>1,950 g, haze 2.4%, and extractables 0.9%. It is sealed at 95° C. and gives an average heat seal strength of only 1.6 lb/in.

### COMPARATIVE EXAMPLE 11

A commercial VLDPE, Exact 3125 (product of ExxonMobil Chemical Company) is converted into a film by the same process as described in Example 1. The VLDPE is an ethylene/1-butene copolymer which has a density 0.912 g/cm³, Mw 111,000, Mw/Mn 2.77, and MI₂ 1.1 dg/min. The film exhibits much lower average heat seal strength than those in Examples 1-4. The film has an MD modulus 17,000 psi, MD tear 105 g, dart-drop strength 1330 g, haze 3.2%, and extractables 0.7%. It is sealed at 95° C. and gives an average heat seal strength of only 1.25 lb/in.

### COMPARATIVE EXAMPLE 12

A commercial LLDPE, Exceed 1018 (product of ExxonMobil Chemical Company) is converted into a film by the same process as described in Example 1. The LLPDE is an ethylene/1-hexene copolymer which has a density 0.919 g/cm³, Mw 112,000, Mw/Mn 2.77, and MI₂ 1.1 dg/min. The film exhibits very low average heat seal strength. The film has an MD modulus 24,900 psi, MD tear 275 g, dart-drop strength 1250 g, and haze 12%. It is sealed at 95° C. and gives an average heat seal strength of 0 lb/in.

TABLE 1
Summary of Polymer Properties and Film Properties

| | | | | | | | Film Properties | | | | | | |
|---|---|---|---|---|---|---|---|---|---|---|---|---|---|
| Polymer Properties | | | | | | | | Heat Seal | MD | | | | |
| Ex. | | Density | | | | MI₂ | Thickness | Strength | Modulus | MD | Dart- | | |
| No. | Cat. | g/cm³ | Comonomer | Mw | Mw/Mn | g/cm³ | mil | lb/in | psi | Tear g | drop g | Haze % | Extractables % |
| 1 | I | 0.911 | 1-hexene | 114,350 | 2.88 | 1.1 | 1.0 | 1.75 | 16600 | 91 | 1715 | 6.1 | 0.77 |
| 2 | I | 0.908 | 1-hexene | 114400 | 2.95 | 1.1 | 1.0 | 1.9 | 14300 | 91 | 1690 | 6.1 | 0.99 |
| 3 | II | 0.907 | 1-butene | 116000 | 2.36 | 1.0 | 1.0 | 1.8 | 15000 | 100 | 840 | 18⁽¹⁾ | 0.8 |
| 4 | II | 0.904 | 1-butene | 113000 | 2.45 | 1.0 | 1.0 | 2.5 | 11700 | 67 | 1060 | 16⁽¹⁾ | 1.2 |
| C5 | II | 0.911 | 1-butene and 1- | 114000 | 2.34 | 1.0 | 1.0 | 1.4 | 16600 | 175 | 1200 | 9.2 | N/A |
| | | | hexene | | | | | | | | | | |
| C6 | II | 0.915 | 1-hexene | 108000 | 2.43 | 1.1 | 1.0 | 0.8 | 19000 | 210 | 1690 | 9.4 | N/A |
| C7 | N/A | 0.910 | 1-octene | 87,400 | 2.68 | 1.0 | 1.0 | 1.25 | 14500 | 140 | >1950 | 3.7 | 0.5 |
| C8 | N/A | 0.905 | 1-octene | 92600 | 2.63 | 1.0 | 1.0 | 1.25 | 10000 | 155 | >1950 | 3.0 | 1.0 |
| C9 | N/A | 0.912 | 1-octene | 128000 | 4.23 | 1.0 | 1.0 | 1.5 | 18000 | 285 | >1950 | 4.9 | 1.97 |
| C10 | N/A | 0.902 | 1-hexene | 111000 | 2.49 | 1.1 | 1.0 | 1.6 | 9770 | 100 | >1950 | 2.4 | 0.9 |
| C11 | N/A | 0.912 | 1-butene | 111000 | 2.77 | 1.1 | 1.0 | 1.25 | 17000 | 105 | 1330 | 3.2 | 0.7 |
| C12 | N/A | 0.919 | 1-hexene | 112000 | 2.77 | 1.1 | 1.0 | 0 | 24900 | 275 | 1250 | 12⁽²⁾ | N/A |

⁽¹⁾Contains 10,000 ppm talc antiblock
⁽²⁾Contains 5,000 ppm talc antiblock

1. A film made from a very low density polyethylene (VLDPE) having a density within the range of about 0.880 to 0.914 g/cm³, said film having a seal initiation temperature less than or equal to 95° C, an average heat seal strength greater than or equal to 1.75 lb/in, and a machine-direction (MD) modulus greater than or equal to 12,000 psi, wherein the seal strength and MD modulus are measured at 1 mil film thickness.

2. The film of claim 1 wherein the MD modulus is greater than or equal to 14,000 psi.

3. The film of claim 1 wherein the MD modulus is greater than or equal to 16,000 psi.

4. The film of claim 1 wherein the density is within the range of about 0.880 to about 0.912 g/cm³.

5. The film of claim 1 wherein the density is within the range of about 0.900 to about 0.912 g/cm³.

6. The film of claim 1 wherein the average heat seal strength is greater than or equal to 2.0 lb/in.

7. The film of claim 1 wherein the average heat seal strength is greater than or equal to 2.5 lb/in.

8. The film of claim 1 having an amount of extractables less than about 0.6% of the film weight.

9. The film of claim 1 having a haze less than about 30%.

10. The film of claim 1 having an MD tear strength greater than about 50 grams.

11. The film of claim 1 having a dart-drop strength greater than about 1,200 grams.

12. The film of claim I wherein the VLDPE is made by a polymerization using an indenoindolyl-based single-site catalyst.

13. The film of claim 1 wherein the VLDPE is a copolymer of ethylene and 1-butene or a copolymer of ethylene and 1-hexene.

14. The film of claim 1 wherein the VLDPE has a melt index MI₂ within the range of 0.5 dg/min to 30 dg/min.

15. The film of claim 1 wherein the MI₂ is within the range of 0.5 dg/min to 5 dg/min.

16. The film of claim 1 wherein the MI₂ is within the range of 0.8 dg/min to 1.2 dg/min.

17. A method for making the film of claim 1, said method comprising preparing a VLDPE by a polymerization using an indenoindolyl-based single-site catalyst and converting the VLDPE into a film.

18. A multilayer film comprising the film of claim 1.
